(19) United States
(12) Patent Application Publication
(10) Pub. No.: US 2004/0043120 A1
(43) Pub. Date: Mar. 4, 2004

(54) Method of and apparatus for processing polished rice

(75) Inventors: Shigeharu Kanemoto, Tokyo (JP); Nobuhiro Matsumoto, Tokyo (JP)

Correspondence Address: STAAS & HALSEY LLP, SUITE 700, 1201 NEW YORK AVENUE, N.W., WASHINGTON, DC, 20005, US

(73) Assignee: SATAKE CORPORATION, Tokyo (JP)

(21) Appl. No.: 10/649,617

(22) Filed: Aug. 28, 2003

(30) Foreign Application Priority Data
Mar. 7, 2002 (JP) 061551/2002

(51) Int. Cl. A23P 1/00

(52) U.S. Cl. 426/481

(57) ABSTRACT

A method of and an apparatus for processing polished rice capable of enhancing whiteness and also providing high brilliance on grain surfaces of processed polished rice. The method comprises the steps of adding moisture to the polished rice to soften grain surfaces thereof; mixing and stirring starchy granular material heated to have temperature not less than 60° C. with the moistened polished rice so that bran stuck on the grain surfaces of the polished rice is captured by the starchy granular material and removed; and separating the polished rice from the starchy granular material with bran captured, and smoothing the grain surfaces by eliminating minute inequalities thereof after the bran removed so as to enhance brilliance of the grain surfaces. The polished rice processing apparatus of the present invention comprises moisture adding means, mixing/stirring means and separating/smoothing means for carrying out the above respective steps of the polished rice processing method.

### BACKGROUND OF THE INVENTION

1. Field of the Invention

The present invention relates to a method of and an apparatus for processing polished rice to obtain no-bran rice which requires no washing before cooking.

2. Description of Related Art

There is known an apparatus for manufacturing no-bran cereal as shown in FIG. 6 from Japanese Patent No. 3206752. This no-bran cereal manufacturing apparatus comprises a wet processing section 105, a mixing/stirring section 110 and a separating/drying section 116 which are arranged substantially parallel to one another and horizontal.

The wet processing section 105 includes a first screw cylinder 101, a first screw shaft 103 rotatably supported in the first screw cylinder 101 and having stirring vanes 102, a spray nozzle 104 for spraying water to the material polished rice at the proximal end portion of the first screw cylinder 101. The mixing/stirring section 110 is arranged under the wet processing section 105 and comprises a second screw cylinder 106 having substantially the same size as the first screw cylinder 101 and a second screw shaft 108 rotatably supported in the second screw cylinder 106 and having stirring vanes 107. A hopper 109 for supplying starchy granular material is connected to the proximal end portion of the second screw cylinder 106. The separating/drying section 116 is arranged below the mixing/stirring section 110 and comprises a screen cylinder 111 having a number of slits, an air inlet 112 arranged above the screen cylinder 111, a cylindrical casing 113 covering the screen cylinder 111, an air discharge duct 114 connected to the bottom of the cylindrical casing 113, and an outlet 115 for taking out the processed polished rice (no-bran rice) arranged at the distal end of the screen cylinder 111.

In the wet processing section 105, a predetermined amount of material polished rice is supplied into the first screw cylinder 101 and moisture of approximately 5% by weight in the form of mist is added to the material polished rice from the spray nozzle 104 so that the moisture permeates over each grain surface of the polished rice to soften bran stuck on each grain surface. In the mixing/stirring section 110, the polished rice with moisture added is mixed and stirred with starchy granular material of high temperature of 60° C.-120° C. from the hopper 109 in the second screw cylinder 106.

The bran stuck on the grain surface of the polished rice which has been softened by the moisture added is gelatinized immediately after touching with the starchy granular material of high temperature and is caught by the granular material and removed from the surface of each grain of the polished rice. Since the bran 3 is securely caught by the starchy granular material 4, the bran 3 does not adheres to the surface of the grains again.

In the separating/drying section 116, the polished rice and the granular material fed into the screen cylinder 111 are stirred to be separated from each other. The polished rice is dried by the air of 40° C. from the air inlet 112 to assist separation of the polished rice from the granular material. The polished rice removed from the granular material is discharged outside from the processed polished rice outlet 115, and the granular material dropped from the slits of the screen cylinder 111 is discharged from the blowing discharge duct 114.

In the above apparatus for manufacturing no-bran cereal, the bran stuck on the softened rice is effectively absorbed by the starchy granular material to enhance whiteness of the no-bran rice, and friction among the grains of polished rice and the starchy granular material are low to suppress generation of powdered bran since the pressure in the second screw cylinder 106 of the mixing/stirring section 110 is relatively low such as 20 gf/cm². However, there has been found a problem that the obtained no-bran rice has low brightness. It is considered that the low brightness is caused by inequalities of the grain surface of the no-bran rice. Since the bran is removed from minute grooves of commissure of the grain, the minute grooves are left on the grain surface to make inequalities of the surface. Thus, light impinged on the minute inequalities diffuses to increase the whiteness but lower the brightness, as shown in FIG. 5.

There is known a method of polishing rice from Japanese Patent Publication No. 54-13383 in which water in the form of liquid, moistened air, steam is added to material polished rice to be soften grain surfaces and the moistened rice is stirred to be subjected to polishing, removing of bran, heating, grinding to thus smooth the gain surfaces by friction among the grain surfaces softened by adding moisture, and dry the grain surfaces utilizing heat produced in this process, to produce brightness of the grain surfaces.

However, in this method of smoothing the grain surfaces by friction among grains with the surface softened by moistening, if the moisture is insufficient, the bran stuck on the grain surface is not effectively removed but embedded into minute grooves on the grain surfaces to fail in enhancing the whiteness.

### SUMMARY OF THE INVENTION

The present invention provides a method of and an apparatus for processing polished rice capable of effectively removing bran stuck on grain surfaces of polished rice to enhance whiteness and also smoothing the grain surfaces to remove minute grooves thereon to have high brilliance.

A method of processing polished rice of the present invention comprises the steps of: adding moisture to the polished rice to soften grain surfaces thereof; mixing and stirring starchy granular material heated to have temperature not less than 60° C. with the moistened polished rice so that bran stuck on the grain surfaces of the polished rice is captured by the starchy granular material and removed; and separating the polished rice from the starchy granular material with bran captured, and smoothing the grain surfaces by eliminating minute inequalities thereof after the bran removed so as to enhance brilliance of the grain surfaces.

The starchy granular material may have granularity of 0.5 mm-1.7 mm, so that the bran stuck on the grain surface is easily captured by the starchy granular material and the starchy material mixed into the polished rice can be effectively separated from the polished rice.

The starchy granular material may have moisture not higher than 5% in weight, so that the bran moistened is easily caught by the starchy granular material having less moisture.

The starchy granular material may be selected from the group consisting of grinded wheat, grinded barleycorn, grinded millet, grinded buckwheat and grinded kaoliang, and may comprise pearl tapioca, which are all edible and available with low cost.

It is preferable to perform smoothing of the grain surfaces by eliminating minute inequalities thereof after the bran removed under pressure in a range between 40 μl/cm² and 100 gf/cm².

The present invention also provides a polished rice processing apparatus comprising moisture adding means, mixing/stirring means and separating/smoothing means for carrying out the above respective steps of the polished rice processing method.

The moisture adding means may include a screw cylinder arranged horizontally, a screw shaft rotatably arranged in the screw cylinder and having stirring vanes, and a spray nozzle for spraying water to material polished rice. The mixing/stirring means may include a cylindrical casing arranged horizontally, a first hollow stirring shaft arranged rotatably in the cylindrical casing and having stirring slats, and a granular material supplying device for supplying the starchy granular material into the cylindrical casing through the hollow stirring shaft. The separating/smoothing means may include a porous wall cylinder arranged horizontally, a second hollow stirring shaft supported rotatably in the porous wall cylinder and having stirring slats, and an air blowing device for blowing air into the porous wall cylinder through the hollow stirring shaft.

The mixing/stirring means and the separating/smoothing means may be connected coaxially by aligning said cylindrical casing and said porous wall cylinder and joining said first hollow stirring shaft and said second hollow stirring shaft to extend coaxially as a unit, so as to make the apparatus compact.

The separating/smoothing means may have a grain discharge device at a distal end portion thereof, and a resistance device may be provided at the grain discharge device for adjusting pressure in the porous wall cylinder. It is preferable to set the pressure in the porous wall cylinder in a range between 40 gf/cm² and 100 gf/cm².

### BRIEF DESCRIPTION OF THE DRAWINGS

FIG. 1 is an enlarged schematic view of a grain surface of polished rice softened by adding moisture when bran stuck on the grain surface is captured by starchy granular material;

FIG. 2 is an enlarged schematic view of the grain surface of no-bran rice with the bran removed from the grain surface;

FIG. 3 is an enlarged schematic view of the grain surface of the no-bran rice after subjected to smoothing process;

FIG. 4 is a vertical sectional view of a polished rice processing apparatus according to the present invention;

FIG. 5 is a schematic diagram of a grain of the polished rice showing diffusion of light by minute inequalities of a grain surface; and

FIG. 6 is a vertical sectional view of a no-bran cereal manufacturing apparatus according to prior art.

### DETAILED DESCRIPTION OF PREFERRED EMBODIMENTS

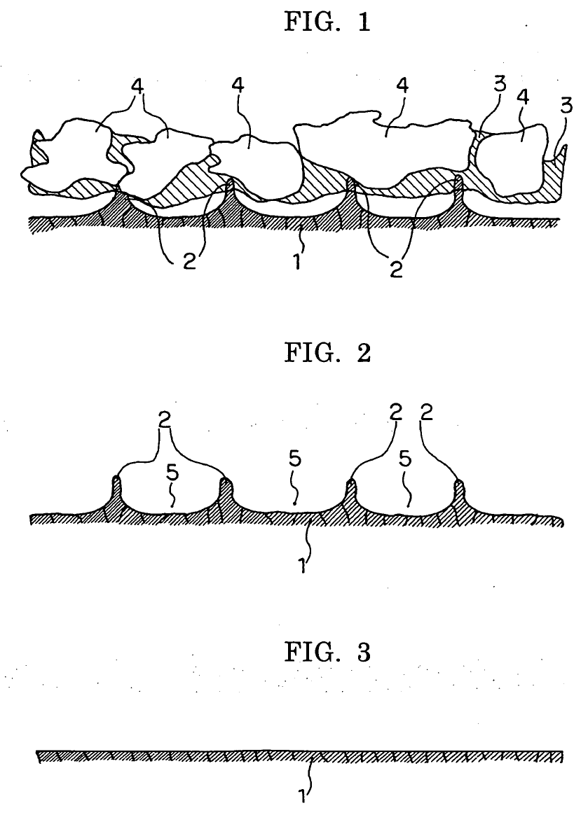

First, a principle of the method of the present invention will be described referring to FIGS. 1-3.

There remains bran 3 on a grain surface 1 of polished rice comprising commissure after subjected to an ordinary polishing process. The bran 3 comprises a part of aleurone of the aleurone layer remaining on the grain surface 1, and a part of the aleurone powdered after removed form the grain surface 1 by the polishing process and adhered thereon. By adding moisture to the grain surface 1 of the polished rice, moisture in the bran stuck on the grain surface 1 is increased so that the bran 3 is swelled with moisture and softened to form a gap between the bran 3 and the grain surface 1.

The starchy granular material 4 having temperature not less than 60° C. preferably in a range of 60° C.-120° C. is mixed to the moistened rice and stirred. The bran 3 on the grain surface 1 is gelatinized by heat from the starchy granular material 4 immediately after touching with the starchy granular material 4. An appetence between the gelatinized bran 3 and the starchy granular material 4 gelatinized by heat as well is enhanced and thus a cross link is formed between the bran 3 and the starchy granular material 4, so that the bran 3 adheres to and caught by the starchy granular material 4, as shown in FIG. 1.

The bran 3 is easily removed as being caught by the starchy granular material 4 form the grain surface 1 without causing any damage on the grain surface 1, as shown in FIG. 2. The grains of polished rice with the bran 3 removed are separated form the granular material 4 catching the bran 3 so that no-bran rice with no bran remaining in the minute recesses or grooves of the grains is obtained.

However, although the bran 3 is removed from the grain surface 1, parts of the commissure remain on the grain surface 1 as protrusions 2 to form minute grooves 5 between the protrusions 2, as shown in FIG. 2. Light impinged on the grain surface 1 diffuses on the surface because of the protrusions 2 and the minute grooves 5 to lower brilliance of the grain surface 1. According to the method of the present invention, the protrusions 2 are scraped to even the grooves 5 to smooth the grain surface 1 by mutual friction among the grains to have high brilliance, as shown in FIG. 3. It is preferable to set pressure of mutual friction in the smoothing process in a range of 40-100 gf/cm².

As the starchy granular material 4, grinded rice, grinded wheat or barleycorn, grinding millet, buckwheat and kaoliang with granularity adjusted in a range from 0.5 mm to 1.7 mm and dried to have moisture not higher than 5% can be used. Also, granular material such as pearl tapioca obtained by processing starch of cassava to be pre-gelatinized and being dried and formed into balls is preferably used.

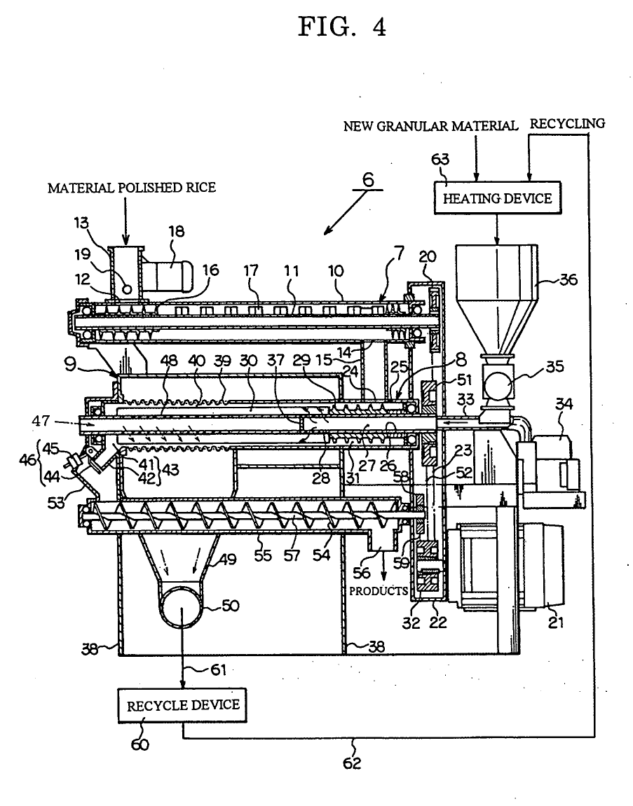

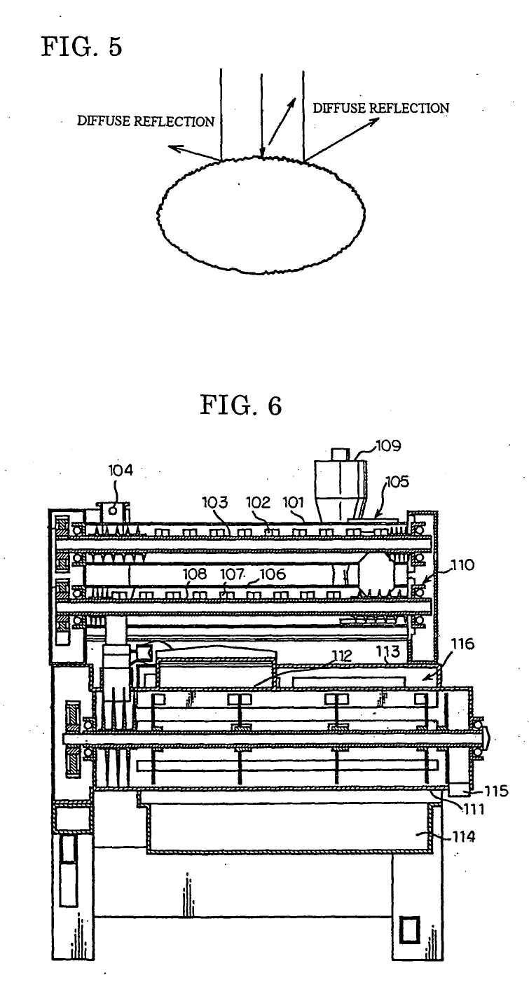

A polished rice processing apparatus for carrying out the method of processing the polished rice will be explained referring to FIG. 4.

The polished rice processing apparatus 6 comprises a moisture adding section 7 for adding moisture to the material polished rice so as to soften bran remaining on the grain surfaces of the material polished rice, a mixing/stirring section 8 for mixing and stirring preheated starchy granular material with the moistened polished rice so that the granular material captures the softened bran on the surfaces of the polished rice, and a separating/smoothing section 9 for separating the processed polished rice from the starchy granular material and burnishing the grain surface.

In this embodiment, the moisture adding section 7 is arranged at the uppermost position in the polished rice processing apparatus 6, the mixing/stirring section 8 and the separating/smoothing section 9 are connected with each other to extend coaxially at the middle position of the polished rice processing apparatus 6 so as to make the apparatus compact.

The moisture adding section 7, the mixing/stirring section 8 and the separating/smoothing section 9 may be provided separately and connected by appropriate grain shifters. Further, the moisture adding section 7 may be arranged at the uppermost position, the mixing/stirring section 8 may be arranged at the middle position and the separating/smoothing section 9 may be arranged at the lowermost position in one polished rice processing apparatus.

The moisture adding section 7 comprises a screw cylinder 10 arranged horizontally and a screw shaft 11 rotatably supported in the screw cylinder 10. A supply cylinder 13 for supplying the material polished rice into the screw cylinder 10 is arranged at the proximal end portion of an upper circumference of the screw cylinder 10, and a communicating pipe 15 communicating an outlet 14 at the distal end portion of the screw cylinder 10 and an inlet 24 at the proximal portion of the mixing/stirring section 8.

The screw shaft 11 has a screw blade 16 at the proximal portion under the supply cylinder 13 and a plurality of stirring vanes 17 in the region between the screw blade 16. A spray nozzle 19 is arranged to be directed into the supply cylinder 13 to spray water to the material polished rice fed into the supply cylinder 13, and a motor 18 for driving a feeder (not shown) for feeding the material polished rice is provided at the supply cylinder 13. A pulley 20 fixed to the distal end of the screw shaft 11 is connected with a motor 21 through a belt 23 in a casing 22.

The mixing/stirring section 8 and the separating/smoothing section 9 are arranged coaxially under the moisture adding section 7. The mixing/stirring section 8 comprises a cylindrical casing 25 communicating with the communicating pipe 15 at the proximal end and a hollow stirring shaft 26 rotatably supported in the cylindrical casing 25. The proximal part of the hollow stirring shaft 26 serves as a granular material supplying pipe 27 having granular material supply holes in the vicinity of a partition wall 37 at a distal end of the proximal part. A grain feeding rotor 29 for feeding the grains of the material rice supplied from the inlet 24 is fixed to an outer circumference of the proximal part of the hollow stirring shaft 26, and stirring slats 30 are fixed to an outer circumference in a forward region between the grain feeding rotor 29 and the distal end of the hollow stirring shaft 26. A mixing/stirring chamber 31 is formed between the grain feeding rotor 29 and the stirring slats 30 and an inner circumferential of the cylindrical casing 25.

One end of a granular material supply pipe 33 is connected to the proximal end of the hollow stirring shaft 26 and the other end is connected to a blower 34 for air-conveying the granular material. A hopper 36 for supplying the granular material is connected to the granular material supply pipe 33 at the middle thereof through an adjusting valve 35 for adjusting feeding rate of granular material. The granular material supply pipe 33, the blower 34, the hopper 36, and the adjusting valve 35 constitutes a granular material supplying device. The partition wall 37 separates an inner space of the hollow stirring shaft 26 into a granular material supply passage and an air supply passage at an approximately middle position of the hollow stirring shaft 26.

The separating/smoothing section 9 is arranged continuously and coaxially with the mixing/stirring section 8. The separating/smoothing section 9 is constituted by a porous wall cylinder 39 connected coaxially with the distal end of the cylindrical casing 25 projecting into a machine frame 38, and the distal portion of the hollow stirring shaft 26 having a number of through holes 48. A separating/smoothing chamber 40 is formed between the distal portion of the stirring shaft 26 and an inner circumference of the porous wall cylinder 39 connected with the cylindrical casing 25.

A grain discharge device 43 comprising a discharge pipe 42 with an opening 41 is arranged at the distal end of the separating/smoothing chamber 40 in an outlet flume 53. A resistance device 46 for adjusting pressure in the separating/finishing chamber 40 is provided at the grain discharge device 43. The resistance device 46 comprises a resistant lid 44 for applying resistive force on the grains being discharged from the discharge pipe 42 and a weight 45 for producing the resistive force of the resistant lid 44. The inner pressure of the separating/smoothing chamber 40 can be adjusted in a range of 40-100 gf/cm² by the resistance device 46.

An air inlet 47 for taking open air is provided at the distal end of the hollow stirring shaft 26, and a number of through holes 48 are formed on circumference of the hollow stirring shaft 26 confronting the porous wall cylinder 39. A funnel 49 for collecting the granular material separated from the processed polished rice (no-bran rice) is provided under the porous wall cylinder 39, and connected with a conducting pipe 50 and a suction fan (not shown). Air introduced into the stirring shaft 26 from the inlet 47 flows through the through holes 48, the separating/smoothing chamber 40, the porous wall cylinder 39, the funnel 49 and the conducting pipe 50 to the suction fan.

A pulley 51 fixed to one end of the stirring shaft 26 is connected with the motor 21 through a belt 52 in the casing 22.

A conveying device having a screw conveyer 54 and a conveyer cylinder 55 is arranged below the separating/smoothing section 9 to be connected to the outlet flume 53 of the separating/smoothing section 9 is connected to a proximal end portion of the conveyer cylinder 55, and an outlet 56 for taking out the processed polished rice (no-bran rice) is arranged at the distal end of the conveyer cylinder 55. A pulley 59 fixed to one end of the rotary shaft 57 is connected with the motor 21 through a belt 59 in the casing 22.

A recycle device 60 is connected to the conducting pipe 50 through the pipe 61 for scraping the bran captured on the granular material and recycling the granular material with the bran scraped to be fed to the hopper 36 through the pipe 62 and the heating device 63 for preheating the granular material to have temperature of 100° C.-120° C.

An operation of the polished rice processing apparatus 6 will be described.

Predetermined amount of material polished rice, which is obtained by polishing brawn rice by an rice polishing machine, is supplied into the screw cylinder 10 from the supplying cylinder 13 by the feeding device driven by the motor 18. Moisture of approximately 5% by weight is added to the material polished rice by the mist sprayed from the spray nozzle 19 arranged near the inlet 12. The polished rice with moisture added is stirred by the stirring vanes 17 while being fed towards the distal end portion of the screw cylinder 10 by the screw blade 16 rotating at 500 rpm. By the stirring, moisture supplied in the form of mist permeates over a surface of each grain of the polished rice to soften bran remaining on each grain of the polished rice.

Subsequently, the polished rice is discharged from the screw cylinder 10 through the outlet 14 and fed into the cylindrical casing 25 of the mixing/stirring section 8 from the inlet 24 through the discharge cylinder 15, and is stirred by the feeding rotor 29 and the stirring slats 30. At the same time, the starchy granular material in the hopper 36 is fed into the supply pipe 33 through the feed valve 35 and also pressurized air from the air conveying blower 34 is supplied into the supply pipe 33, so that the starchy granular material is fed into the hollow stirring shaft 26. Since the starchy granular material may be small grains such as pearl tapioca obtained by processing starch to be pre-gelatinized and dried to be form to a ball having a hardness of 2-5 kgf/cm² and a standard granularity of 0.5 mm-1.7 mm, the granular material is conveyed by the air supplied from the blower 34. The granular material is preheated by the heating device 63 to have high temperature of 100° C.-120° C. and supplied into the granular material supply pipe 33. The granular material conveyed into the hollow stirring shaft 26 is blocked by the partition wall 37 and discharged through the through holes 28 to be fed into the mixing/stirring chamber 31.

In the mixing/stirring chamber 31, the starchy granular material which has temperature of 60° C.-100° C. reduced from the temperature of 100° C.-120° C. at the heating device 63 is mixed and stirred with the polished rice. The bran on the surface of each grain of the polished rice which has been softened by the moisture added in the moisture adding section 7 is gelatinized immediately after touching with the granular material of high temperature and is caught by the granular material and removed from the surface of each grain of the polished rice. Since the bran is securely caught by the granular material, the bran does not adheres to the surface of the grains again. The moisture of the bran is evaporated to absorb heat from the surface of each grain to lower the temperature thereof.

The polished rice and the starchy granular material move into the separating/smoothing chamber 40 of the separating/smoothing section 9 and the starchy granular material passes the porous wall cylinder 39 through the through holes to drop into the funnel 49 and the grains of the polished rice remain in the separating/smoothing chamber 40 being restrained by the porous wall cylinder 39 to thus separated from the granular material. The grains of the polished rice remaining in the separating/smoothing chamber 40 are subjected to stirring by the stirring slats 30. At the same time, the air taken from the inlet 47 is introduced into the separating/smoothing chamber 40 through the hollow stirring shaft 26 and the through holes 48 to assist separation of the polished rice from the granular material.

The grains of the polished rice remaining in the separating/smoothing chamber 40 is subjected to stirring by the stirring slats 30 at the pressure in a range between 40 gf/cm² and 100 gf/cm² adjusted by the resistance device 46 provided at the grain discharge portion 42. With this stirring of the grains at the appropriate pressure, the friction mutually acting among the grains scrapes the protrusions 2 on each grain surface of the polished rice to be burnished.

The grains discharged from the grain discharge tube 42 are with bran removed from the surface to enhance whiteness and the protrusions of the grooves are burnished to provide high brightness.

The polished rice passed through the lid 44 drops onto the outlet flume 53 is conveyed by the conveying device and discharged from the outlet 56.

The processes and products by the conventional polished rice processing apparatus as shown in FIG. 6 and the polished rice processing apparatus of the present invention as shown in FIG. 4 are compared as follows;

TABLE 1
(abundance and pressure of mixture of rice gains and starchy
granular material)

| | Prior art | Present invention |
|---|---|---|
| Abundance | Approximately 30% | Approximately 90% |
| Pressure | 20 gf/cm² | 40 gf/cm²-100 gf/cm² |

TABLE 2
(brilliance, whiteness and turbidness of processed rice grain
surfaces)

| | Prior art | Present invention |
|---|---|---|
| Brilliance | Low | High |
| Whiteness | 45%-47% | 45%-47% |
| Turbidness | 60 ppm-70 ppm | 60 ppm-70 ppm |

As described, according to the present invention, bran stuck on grain surfaces of polished rice is effectively removed to enhance whiteness of obtained no-bran rice and also the grain surfaces are smoothed to remove minute grooves thereon to have high brilliance.

What is claimed is:

1. A method of processing polished rice to obtain no-bran rice comprising the steps of:
(a) adding moisture to the polished rice to soften grain surfaces thereof;
(b) mixing and stirring starchy granular material heated to have temperature not less than 60° C. with the moistened polished rice so that bran stuck on the grain surfaces of the polished rice is captured by the starchy granular material and removed; and
(c) separating the polished rice from the starchy granular material with bran captured, and smoothing the grain surfaces by eliminating minute inequalities thereof after the bran removed so as to enhance brilliance of the grain surfaces.

2. A method of processing polished rice according to claim 1, wherein said starchy granular material has granularity of 0.5 mm-1.7 mm.

3. A method of processing polished rice according to claim 1, wherein said starchy granular material has moisture not higher than 5% in weight.

4. A method of processing polished rice according to claim 1, wherein said starchy granular material is selected from the group consisting of grinded wheat, grinded barleycorn, grinded millet, grinded buckwheat and grinded kaoliang.

5. A method of processing polished rice according to claim 1, wherein said starchy granular material comprises pearl tapioca.

6. A method of processing polished rice according to claim 1, wherein said step (c) is performed under pressure in a range between 40 gf/cm² and 100 gf/cm².

7. An apparatus for processing polished rice comprising:
moisture adding means for adding moisture to the polished rice to soften grain surfaces thereof;
mixing/stirring means for mixing and stirring starchy granular material heated to have temperature not less than 60° C. with the polished rice moistened by said moisture adding means so that bran stuck on the grain surfaces of the polished rice is captured by the starchy granular material and removed; and
separating/smoothing means for separating the polished rice from the starchy granular material with bran captured, and smoothing the grain surfaces of the polished rice by eliminating minute inequalities of the grain surfaces after the bran removed so as to enhance brilliance of the grain surfaces.

8. An apparatus for processing polished rice according to claim 7, wherein
said moisture adding means includes a screw cylinder arranged horizontally, a screw shaft rotatably arranged in the screw cylinder and having stirring vanes, and a spray nozzle for spraying water to material polished rice,
said mixing/stirring means includes a cylindrical casing arranged horizontally, a first hollow stirring shaft arranged rotatably in the cylindrical casing and having stirring slats, and a granular material supplying device for supplying the starchy granular-material into the cylindrical casing through the hollow stirring shaft,
said separating/smoothing means includes a porous wall cylinder arranged horizontally, a second hollow stirring shaft supported rotatably in the porous wall cylinder and having stirring slats, and an air blowing device for blowing air into the porous wall cylinder through the hollow stirring shaft.

9. An apparatus for processing polished rice according to claim 8, wherein said mixing/stirring means and said separating/smoothing means are connected coaxially by aligning said cylindrical casing and said porous wall cylinder and joining said first hollow stirring shaft and said second hollow stirring shaft to extend coaxially as a unit.

10. An apparatus for processing polished rice according to claim 9, wherein said separating/smoothing means has a grain discharge device at a distal end portion thereof, and a resistance device is provided at the grain discharge device for adjusting pressure in the porous wall cylinder.

11. An apparatus for processing polished rice according to claim 10, wherein the pressure in the porous wall cylinder is set to 40 gf/cm² to 100 gf/cm².
